(19) United States
(12) Patent Application Publication
(10) Pub. No.: US 2009/0150940 A1
(43) Pub. Date: Jun. 11, 2009

(54) DOWNLOADING OF AN INTERACTIVE APPLICATION TO A BROADCAST PROGRAMMING RECEIVER

(75) Inventor: David Christopher St.John-Larkin, Denver, CO (US)

Correspondence Address: SETTER ROCHE LLP, PO BOX 780, ERIE, CO, 80516, US

(73) Assignee: EchoStar Technologies Corporation, Englewood, CO (US)

(21) Appl. No.: 11/951,016

(22) Filed: Dec. 5, 2007

(51) Int. Cl. G06F 3/02

(52) U.S. Cl. 725/59

(57) ABSTRACT

A broadcast programming receiver includes first and second tuners, a user interface, a memory, output circuitry, and control logic. The first tuner is configured to receive the programming, while the second tuner is configured to receive an interactive application. The user interface is configured to receive a request for the application, and the memory is configured to store the application. The output circuitry is configured to transfer the programming to an output device. The control logic is configured to cause the first tuner to receive the programming, to transfer the programming from the first tuner via the output circuitry to the output device, to receive the request from the user interface, and to cause the second tuner to receive the application and store the application in the memory in response to the request while causing the first tuner to continue to transfer the programming to the output device.

### BACKGROUND

Broadcast programming receivers, such as satellite or cable television set-top boxes (STBs), typically are capable of receiving any of thousands of audio/video programs, such as newscasts, sporting events, movies, and the like, by way of hundreds of separate programming channels made available by a service provider. Reception of such programming is facilitated by one or more tuners within the receiver, with each tuner selecting the desired program as determined by the user out of hundreds of programs being transmitted to the receiver at any one time. The use of multiple tuners further allows reception of multiple programs simultaneously for viewing on a television or video monitor, recording on a data storage device within the receiver for later retrieval, or some combination thereof.

More recently, broadcast programming receivers have also been utilized for reception and execution of interactive applications to allow more user involvement or control compared to simply viewing a program. Such applications often provide access to service provider customer support information, interactive gaming, stock market quotes, weather information, online shopping, and more. Typically, such interactive applications do not reside permanently within the receiver, but are instead downloaded from the service provider via one of the tuners upon request of the user. After the user has finished using the application, the receiver then normally deletes the application to free up internal memory resources for other purposes.

### BRIEF DESCRIPTION OF THE DRAWINGS

FIG. 1 is a block diagram of a broadcast programming receiver according to an embodiment of the invention.

FIG. 2 is a flow diagram of a method for receiving an interactive application according to an embodiment of the invention.

FIG. 3 is a block diagram of a broadcast programming receiver according to another embodiment of the invention.

FIG. 4 is a flow diagram of a method for receiving an interactive application according to another embodiment of the invention.

FIG. 5 is a view of an output device display showing broadcast programming and an indication of the download progress of an interactive application according to an embodiment of the invention.

FIG. 6 is a view of an output device display showing broadcast programming and an interactive application in a picture-in-picture arrangement according to an embodiment of the invention.

### DETAILED DESCRIPTION

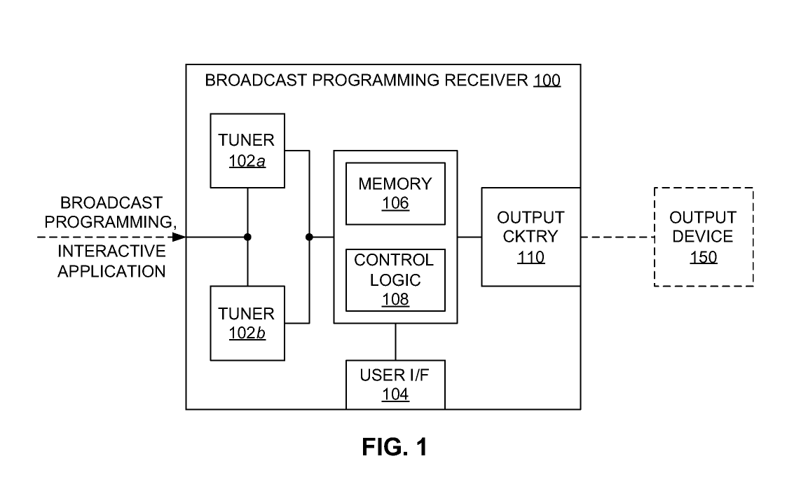

FIG. 1 presents a block diagram of a broadcast programming receiver 100 that includes two tuners 102a, 102b, a user interface 104, a memory 106, control logic 108, and output circuitry 110. The first tuner 102a is configured to receive broadcast programming. The user interface 104 is configured to receive a request for an interactive application, the second tuner 102b is configured to receive the application, and the memory 106 is configured to store the application. The output circuitry 110 is configured to transfer the broadcast programming to an output device 150 coupled with the receiver 100. The control logic 108 is configured to cause the first tuner 102a to receive the broadcast programming, and to transfer the broadcast programming from the first tuner 102a via the output circuitry 110 to the output device 150. The control logic 108 is also configured to receive the request for the interactive application from the user interface 104, and to cause the second tuner 102b to receive the interactive application and store the application in the memory 106 in response to the request while causing the first tuner 102a to continue to transfer the broadcast programming via the output circuitry 110 to the output device 150.

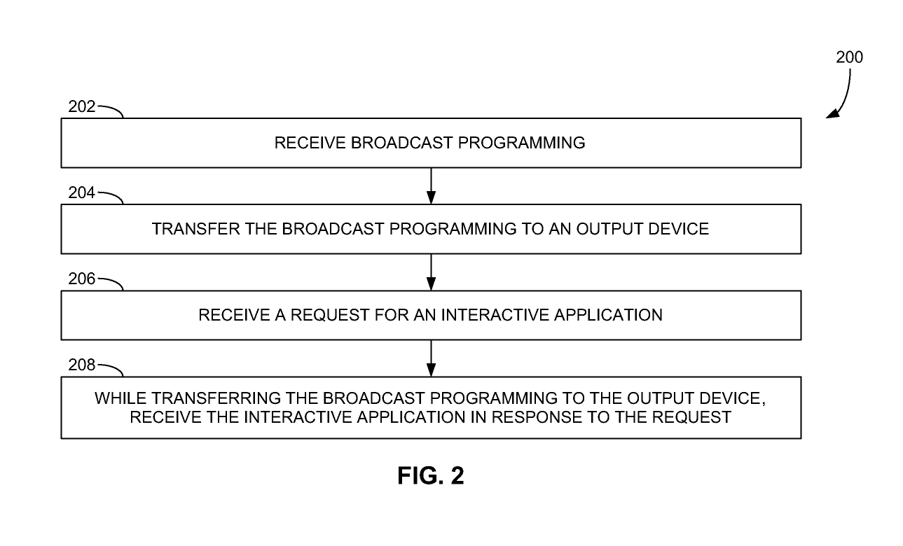

FIG. 2 illustrates by way of a flow diagram a method 200 for receiving an interactive application. The method 200 includes receiving broadcast programming (operation 202) and transferring the broadcast programming to an output device (operation 204). A request for an interactive application is received (operation 206). While transferring the broadcast programming to the output device, the interactive application is received in response to the request (operation 208).

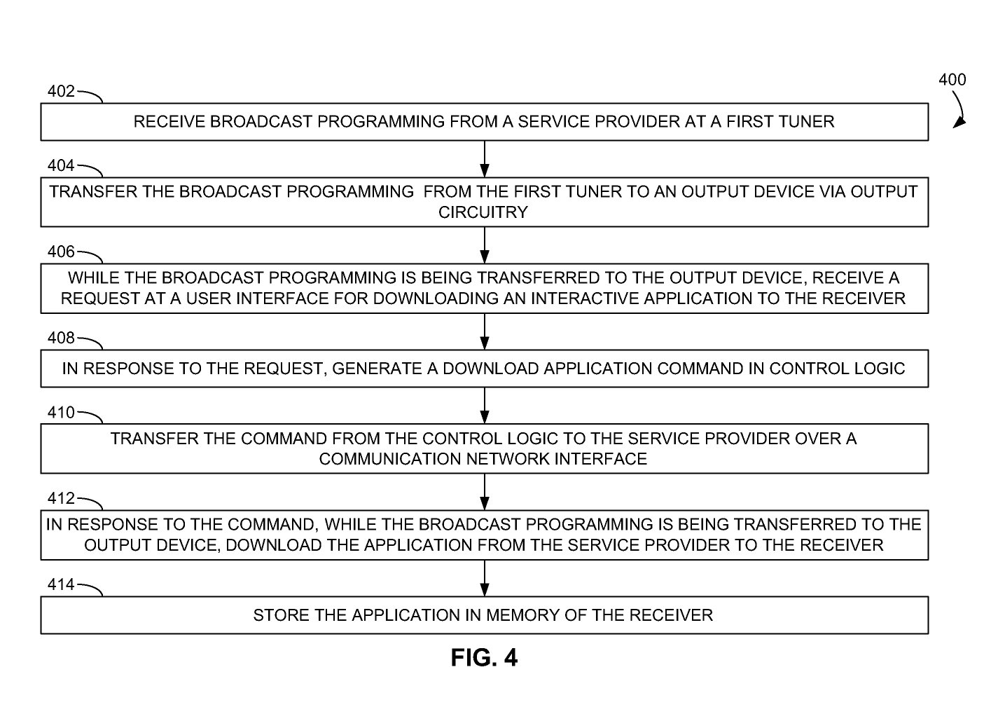

While the flow diagram of FIG. 2, as well as the flow diagram of FIG. 4 discussed below, indicates a particular order of execution of the operations listed above, other orders of execution, including concurrent execution of various operations, may be possible while remaining within the scope of the invention.

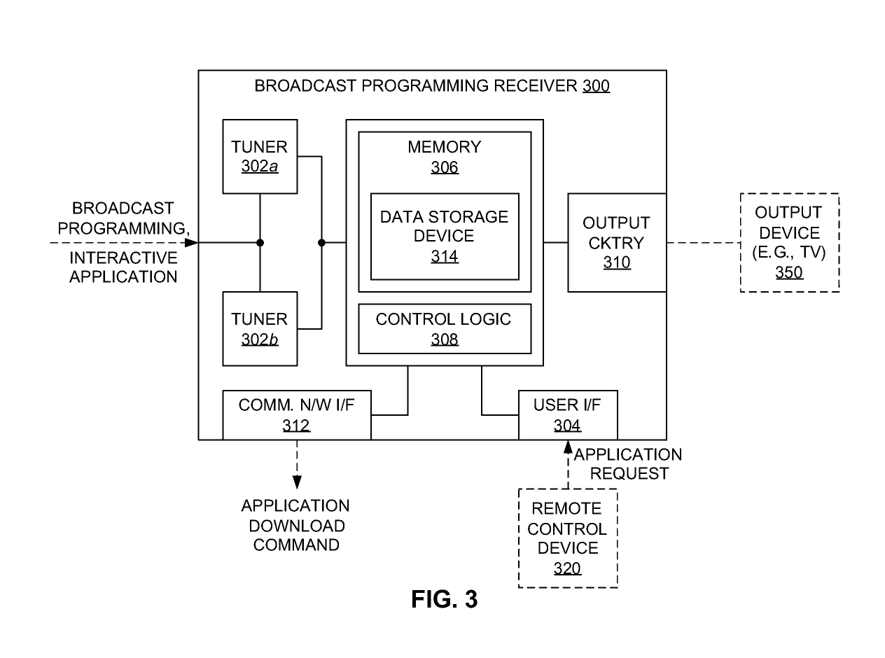

Another embodiment of a broadcast programming receiver 300 is depicted in FIG. 3. The broadcast programming receiver 300 may be any receiver configured to receive broadcast programming, such as audio and/or video programs. Examples of the receiver 300 include, but are not limited to, a satellite television broadcast set-top box (such as a direct broadcast satellite (DBS) receiver), a cable television set-top box, and a satellite radio receiver. In the satellite television broadcast environment, the receiver 300 may be coupled with an output device 350, such as a television, video monitor, or audio amplifier, as shown in FIG. 3, to allow a user to receive the broadcast programming in an audio or visual format. The connection between the receiver 300 and the output device 350 may be any kind of wired or wireless connection suitable for carrying the broadcast programming in a format usable by the output device 350.

The receiver 300 of FIG. 3 includes two tuners 302a, 302b, a user interface 304, memory 306 (including a data storage device 314), control logic 308, output circuitry 310, and a communication network interface 312. Other components not shown in FIG. 3 may be incorporated within the receiver 300, but such components are omitted for the sake of promoting clarity in the following discussion.

Each of the tuners 302a, 302b is configured to receive broadcast programming from an external source, such as from a television broadcast satellite by way of an antenna, or a cable television head-end via a coaxial cable. The tuners 302 may perform a number of functions, such as frequency conversion of an incoming signal, tuning or selection of one or more programming channels or transponders from the incoming signal, and descrambling and/or decoding of one or more of the programming channels for presentation to the user. In addition, some circuitry employed to receive the broadcast programming may be shared between the tuners 302 to reduce the total amount of circuitry required.

In addition, each of the tuners 302 may be configured to receive information other than the broadcast programming. For example, event information relating to an electronic program guide (EPG), such as the channels, dates, and times at which a particular program will be broadcast, may be received by way of either or both of the tuners 302. In the embodiments described herein, each tuner 302 is also capable of receiving one or more interactive applications for execution within the receiver 300.

The output circuitry 310 is configured to transfer the broadcast programming received by either or both of the tuners 302 to the output device 360. The output circuitry 308 may include circuitry for signal formatting, frequency conversion, and the like in order to convert the programming into a form suitable for use by the output device 350. The configuration of the receiver 300 as shown in FIG. 3 employs the memory 306 as a conduit for transferring the broadcast programming from the tuners 302 to the output circuitry 310. In another embodiment, the programming received by the tuners 302 may be transferred directly to the output circuitry 310 to circumvent the memory 306.

The user interface 304 allows a user to input commands or requests for particular actions to be taken by the receiver 300, such as selecting a programming channel by way of one of the tuners 302. In one embodiment, the user interface 304 includes circuitry for receiving input from a user by way of a remote control device 320. Typically, the remote control device 320 sends wireless signals, such as infrared (IR) or ultra-high frequency (UHF) signals in response to keystrokes or other actions initiated by the user on the remote control device 320. The user interface 304 receives and interprets those signals, which are then acted upon by the control logic 308. The user interface 304 may also include user controls located on the receiver 300 that are configured to accept user input. One type of request that may be received by the user interface 304 is a request to download an interactive application, as is discussed in greater detail below.

The communication network interface 312 is configured to send requests or commands generated within the receiver 300 to a service provider, such as the entity providing the broadcast programming to the receiver 300. Depending on the implementation, the communication network interface 312 may be a telephone connection, a cable connection, an Ethernet connection, a wireless connection, or the like capable of communicating over a communication network with the service provider. One example of a command sent via the communication network interface 312 is a command to download an interactive application to the receiver 300 using one of the tuners 302.

The memory 306 is configured to store an interactive application received by one of the tuners 302. The memory 306 may include read-only memory (ROM), random-access memory (RAM), or both. Other forms of digital memory storage may be employed in other implementations. The memory 306 may also include a mass data storage device 314, such as a magnetic or optical disk drive. The memory 304 may serve a number of functions, such as storage for instructions and data related to software or firmware executed by the control logic 308. The mass data storage device 314 may also provide sufficient storage for one or more programs received via one or both of the tuners 302, thus facilitating digital video recorder (DVR) functionality in the receiver 300.

Coupled with the memory 306 is the control logic 308, which operates to control one or more components of the broadcast programming receiver 300, such as any of the tuners 302, the user interface 304, the communication network interface 312, and the output circuitry 310. The control logic 406 may include a processing unit, such as a microprocessor, microcontroller, or digital signal processor (DSP) executing software or firmware to perform the various control functions discussed herein. In another embodiment, digital hardware control circuitry, or a combination of hardware and software (or firmware) elements, may be employed as the control logic 308.

The control logic 308 is configured to direct and coordinate the activities of the various components of the receiver 300 to perform a number of functions. In one example, the control logic 308 provides the capability to perform a method 400 (shown in FIG. 4) for receiving an interactive application into the receiver 300 of FIG. 3. In other embodiments, the method 400 may be applied to a receiver other than the receiver 300 of FIG. 3 while remaining within the scope of the invention.

In the method 400, broadcast programming is received from a service provider at the first tuner 302a (operation 402). Such programming may be any program, such as a newscast, sporting event, movie, or the like, delivered by way of a satellite (in the case of a direct broadcast satellite (DBS) or other satellite television system) or a cable (in the case of cable television). Other types of broadcast programming, such as terrestrial television programming and satellite radio, may be received in other embodiments.

A portion of the received broadcast programming, typically selected by the user via the user interface 304, is transferred from the first tuner 302a to the output device 350 via the output circuitry 310 (operation 404) under the guidance of the control logic 308. Generally, a single program is selected by the user for viewing at the output device 350, such as a television. In the receiver of FIG. 3, the broadcast programming passes through the memory 306. In one embodiment, the programming is at least temporarily saved on the data storage device 314 to allow the use of “trick” modes, such as rewind, slow motion, fast forward, and the like, to enhance the experience of the user.

While the broadcast programming is being transferred to the output device 350, the receiver 300 may receive a request for downloading an interactive application via the user interface 304 (operation 406). More specifically, a user may indicate via one or more keystrokes of the remote control device 320 to request the download and execution of a specific interactive application displayed to the user via a menu displayed on the output device 350 via the control logic 308 and the output circuit 310. In one implementation, the menu may be displayed on the output device 350 along with the programming, such as by way of an overlay or a picture-in-picture (PIP) arrangement. Further, the menu may specifically be fashioned to allow access to one or more interactive applications related to the content of the broadcast programming being received.

The interactive application being requested may be any application that can be downloaded from a service provider and executed within the receiver 300 at the direction of the user. Examples of interactive applications may include, but are not limited to, a single video stream, multiple video streams to be simultaneously or concurrently displayed, an interactive game, textual information (such as news articles, sports statistics, stock market information, weather data, and the like), billing information sourced by the service provider, customer support information regarding the service provider or the receiver 300, and shopping information.

In one implementation, the informational content of the interactive application being downloaded is associated in some fashion with the broadcast programming being transferred to the output device 350. For example, the application may retrieve and present information, such as game and player statistics, player and coach biographies, and the like, in conjunction with a football or baseball game being received by the receiver 300. In another example, the application may allow access to alternate video streams originating from the same sporting event being received at the receiver 300.

In response to the request, the control logic 308 generates a download application command (operation 408) and transfers the command to the service provider over the communication network interface 312 (operation 410). In the case that more than one interactive application is available for download, the download application command may indicate the identity of the specific application requested, as determined by the user via the menu discussed above.

In response to the command, the service provider downloads the requested application, which is received at the receiver 300 (operation 412) and stored in the memory 306 (operation 414) under the direction of the control logic 308. The portion of the memory 306 storing the application may be nonvolatile memory, such as RAM, or the data storage device 314. The control logic 308 may perform the generation of the command requesting the application, as well as the reception and storing of the application, by way of a client-side application configured to communicate with the service provider. In the embodiment of FIG. 3, the application is received by way of the second tuner 302b over the same external path that the broadcast programming is received. In another implementation, the application may be transferred to the receiver 300 through the communication network interface 312. The downloading and storing of the application occurs while the received broadcast programming is being transferred from the first tuner 302a through the output circuitry 310 to the output device 350. As a result, viewing of the programming is not interrupted at the output device 350 while the application is being downloaded. Further, the length of time during which the user may view the programming while the download occurs may be significant, depending on the size of the application, the available bandwidth of the communication pathway being used to download the application, and other potential factors.

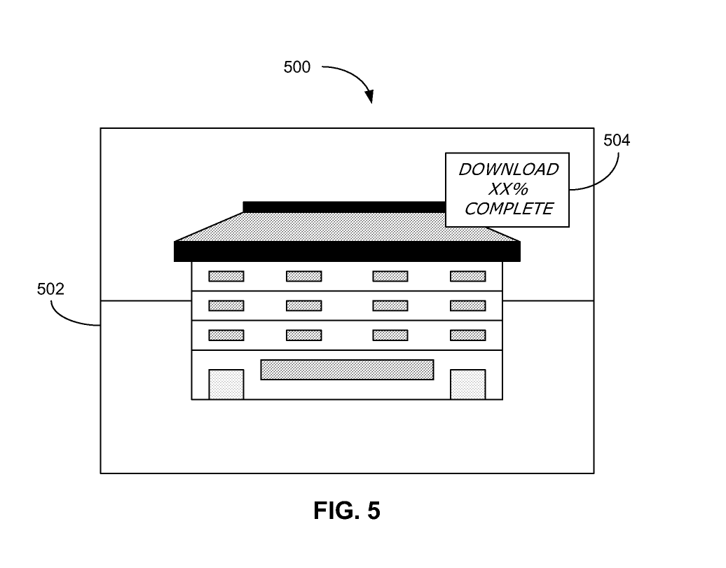

After the user requests the download of the application through the user interface 304 (operation 406), the control logic 308 may display status information regarding the reception of the interactive application through the second tuner 302b. FIG. 5 presents a view 500 of a display of the output device 350 in which the broadcast programming 502 is presented to the user while a download progress indication 504 is displayed in a PIP arrangement. A simple overlay of the download progress indicator 504 may be shown in other implementations. The download progress indicator 504 may be represent any of several different types of information, such as the percentage of the application that has been downloaded (as shown in FIG. 5), the number of bytes that have been downloaded, an estimated amount of time remaining until the download is complete, and so on.

Once the downloading process has been completed, control logic 308 may react in a number of ways. In one embodiment, the control logic 308 may cease the transfer of the broadcast programming to the output device 350 so that the output device 350 may be employed to display any visual component or representation of the application to the user. This action may be performed automatically by the control logic 308 upon completion of the download, or the user may instigate the action through the user interface 304. The control logic 308 may also allow the user access to direct the application via the user interface 304. In a further embodiment, the control logic 308 may begin storing in the data storage device 314 the broadcast programming being received through the first tuner 302a no later than the time at which the control logic 308 ceases transfer of the programming to the output device 350. As a result, the user may view the previously unseen portions of the programming that were broadcasted while the user was interacting with the application.

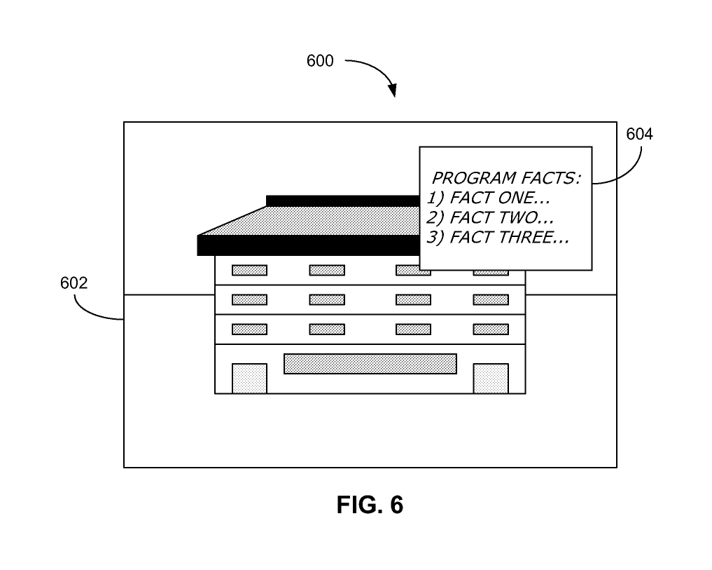

In another implementation, the control logic 308 provides access to the interactive application via the user interface 304 and the output device 350 while the first tuner 302b continues to transfer the broadcast programming to the output device 350. FIG. 6 depicts a view 600 of the display of the output device 350 in which the broadcast programming 602 continues to be shown in conjunction with a representation of the application 604. Depending on the type of view presented by the application to the user, the application may be shown as an overlay (such as textual information), a PIP display (such as for graphical information or a video stream), or some other format. In another embodiment, the application may be presented in an equal or larger portion of the display compared to that for the broadcast programming. For example, the programming may be shown in a PIP display while the application occupies the majority of the display of the output device 350.

Generally, the embodiments described above may provide the advantage of allowing the user to continue to use a broadcast programming receiver for viewing programming while a requested interactive application is being downloaded. Additionally, the progress of the download operation may be monitored while the programming is being displayed. Once the download operation has been completed, the transfer of the broadcast programming to the television or other output device may be terminated to allow unfettered access to the application. During the execution of the application, the unviewed portion of the programming may be stored internally for later viewing by the user after execution of the application is terminated. Alternatively, the access to the application and viewing of the programming may continue simultaneous, which may be advantageous if the application and the programming are related in some fashion.

Given the number of options available to the user in operating the receiver 300, one embodiment may allow the user to determine the actions of the receiver 300 before, during, and after the download of an application as described above. In one example, the user may utilize a menu shown on the output device 350 and accessible via the user interface 304, as described above, to predetermine the actions of the control logic 308 in displaying the broadcast programming during and after the download of the application.

While several embodiments of the invention have been discussed herein, other embodiments encompassed by the scope of the invention are possible. For example, while embodiments of the invention have been described primarily in connection with satellite and cable television broadcast programming receivers, other programming receivers, such as terrestrial television receivers and satellite radio receivers, may benefit from implementation of the concepts described herein. Also, aspects of one embodiment may be combined with those of alternative embodiments to create further implementations of the present invention. Thus, while the present invention has been described in the context of specific embodiments, such descriptions are provided for illustration and not limitation. Accordingly, the proper scope of the present invention is delimited only by the following claims and their equivalents.

What is claimed is:

1. A broadcast programming receiver, comprising:
a first tuner configured to receive broadcast programming;
a user interface configured to receive a request for an interactive application;
a second tuner configured to receive the interactive application;
a memory configured to store the interactive application;
output circuitry configured to transfer the broadcast programming to an output device; and
control logic configured to cause the first tuner to receive the broadcast programming, to transfer the broadcast programming from the first tuner via the output circuitry to the output device, to receive the request from the user interface, and to cause the second tuner to receive the interactive application and store the interactive application in the memory in response to the request while causing the first tuner to continue to transfer the broadcast programming via the output circuitry to the output device.

2. The broadcast programming receiver of claim 1, further comprising:
a communication network interface configured to send an application download command;
wherein the control logic is configured to generate the application download command in response to the request, and to transfer the application download command via the communication network interface to a service provider to initiate transmission of the interactive application to the second tuner.

3. The broadcast programming receiver of claim 1, wherein the control logic is configured to provide access to the interactive application via the user interface, to transfer a representation of the interactive application via the output circuitry to the output device, and to cease transfer of the broadcast programming to the output device after the interactive application is stored in the memory.

4. The broadcast programming receiver of claim 3, wherein:
the memory comprises a data storage unit coupled with the first tuner; and
the control logic is configured to store the broadcast programming in the data storage unit in response to ceasing transfer of the broadcast programming to the output device.

5. The broadcast programming receiver of claim 1, wherein the control logic is configured to provide access to the interactive application via the user interface, and to continue transfer of the broadcast programming via the output circuitry to the output device after the interactive application is received.

6. The broadcast programming receiver of claim 5, wherein the control logic is configured to display the broadcast programming and a representation of the interactive application on the output device while providing access to the interactive application via the user interface.

7. The broadcast programming receiver of claim 1, wherein the interactive application comprises at least one of a single video stream, a multiple video stream, a gaming application, textual information, billing information, customer support information, and shopping information.

8. The broadcast programming receiver of claim 1, wherein informational content of the interactive application is associated with the broadcast programming.

9. The broadcast programming receiver of claim 8, wherein the informational content of the interactive application comprises statistics related to the broadcast programming.

10. The broadcast programming receiver of claim 8, wherein the informational content of the interactive application comprises an alternate video stream related to the broadcast programming.

11. The broadcast programming receiver of claim 8, wherein the control logic is configured to present a user menu on the output device via the output circuitry to facilitate the request for the interactive application while causing the first tuner to continue to transfer the broadcast programming to the output device.

12. The broadcast programming receiver of claim 1, wherein the control logic is configured to present status information regarding the second tuner receiving the interactive application.

13. The broadcast programming receiver of claim 12, wherein the status information comprises a download progress indicator.

14. The broadcast programming receiver of claim 1, wherein:
the broadcast programming receiver comprises one of a satellite set-top box and a cable set-top box; and
the output device is one of a television and a video monitor.

15. A method for receiving an interactive application, the method comprising:
receiving broadcast programming;
transferring the broadcast programming to an output device;
receiving a request for an interactive application; and
while transferring the broadcast programming to the output device, receiving the interactive application in response to the request.

16. The method of claim 15, further comprising indicating progress of the receiving of the interactive application.

17. The method of claim 15, wherein the interactive application is logically related to the broadcast programming.

18. The method of claim 15, further comprising:
after receiving the interactive application, providing user access to the interactive application; and
after receiving the interactive application, terminating transfer of the broadcast programming to the output device and storing the broadcast programming for later retrieval.

19. The method of claim 15, further comprising:
after receiving the interactive application, providing user access to the interactive application; and
after receiving the interactive application, continuing transfer of the broadcast programming to the output device.

20. The method of claim 19, further comprising:
concurrently displaying the broadcast programming and a representation of the interactive application on the output device while providing access to the interactive application.

21. A computer-readable medium encoded with computer-executable instructions for employing a method for receiving an interactive application, the method comprising:
receiving broadcast programming;
transferring the broadcast programming to an output device;
receiving a request for an interactive application; and
while transferring the broadcast programming to the output device, receiving the interactive application in response to the request.

22. The computer-readable medium of claim 21, wherein the method further comprises:
after receiving the interactive application, providing user access to the interactive application.

23. The computer-readable medium of claim 22, wherein the method further comprises:
after receiving the interactive application, terminating transfer of the broadcast programming to the output device.

24. The computer-readable medium of claim 22, wherein the method further comprises:
after receiving the interactive application, continuing transfer of the broadcast programming to the output device.
